(19) United States
(12) Patent Application Publication
(10) Pub. No.: US 2008/0102228 A1
(43) Pub. Date: May 1, 2008

(54) ADHESIVE, POLARIZER USING THE SAME, AND LIQUID CRYSTAL DISPLAY HAVING THE SAME

(76) Inventors: Sun-Hyung Kim, Seoul (KR); Jong-Oh Kim, Cheonan-si (KR)

Correspondence Address: MACPHERSON KWOK CHEN & HEID LLP, 2033 GATEWAY PLACE, SUITE 400, SAN JOSE, CA, 95110, US

(21) Appl. No.: 11/925,597

(22) Filed: Oct. 26, 2007

(30) Foreign Application Priority Data
Oct. 27, 2006 (KR) 2006-105173

(51) Int. Cl. C09K 19/02; B32B 27/06; C08F 8/30

(52) U.S. Cl. 428/1.54; 428/423.1; 525/123

(57) ABSTRACT

An adhesive, a polarizer using the adhesive, and a liquid crystal display having the polarizer are disclosed. The adhesive includes a polymer compound that is formed by bonding a polymer having an acryl group to a diisocyanate-based compound having an isocyanate group that reacts with the acryl group. The polarizer includes a compensation film and a surface protective film, which are bonded to each other by the adhesive. The liquid crystal display includes a liquid crystal panel and the polarizer which are bonded to each other by the adhesive.

### CROSS-REFERENCE TO RELATED APPLICATION

This application relies for priority upon Korean Patent Application No. 2006-105173 filed on Oct. 27, 2006, the contents of which are herein incorporated by reference in its entirety.

### BACKGROUND OF THE INVENTION

1. Field of the Invention

The present invention relates to an adhesive, a polarizer and a liquid crystal display. More particularly, the present invention relates to an adhesive having an improved physical property, a polarizer using the adhesive and a liquid crystal display having the polarizer.

2. Description of the Related Art

In general, an adhesive is used to bond two different materials to each other. In some cases, the two materials are detachably bonded to each other by means of the adhesive such that they can be separated from each other, if necessary. Due to such a physical property of the adhesive, the adhesive is used for various appliances. For instance, the adhesive is used in a liquid crystal display (LCD) that displays an image by using liquid crystal.

The LCD includes a liquid crystal panel having liquid crystal therein and a polarizer that linearly polarizes light. The liquid crystal panel is bonded to the polarizer by means of the adhesive. The light transmittance may vary depending on the alignment state of the liquid crystal. The LCD controls the alignment direction of the liquid crystal, light that is linearly polarized by means of the polarizer passes through the liquid crystal, and desired images can be displayed.

Optical characteristics of the liquid crystal are very important factors that exert influence upon the operation of the LCD. The bonding strength between the polarizer and the liquid crystal panel may vary depending on the physical property of the adhesive, and the quality of image may be changed according to the bonding strength. In particular, if heat is applied to the polarizer from the exterior, the polarizer is expanded while causing discoloration or stain to the image, so that the image quality may be degraded.

### SUMMARY OF THE INVENTION

Therefore, the present invention provides an adhesive having an improved physical property.

The present invention further provides a polarizer using the adhesive.

The present invention also provides an LCD having the polarizer.

In one aspect, the adhesive includes a polymer compound which is formed by bonding a polymer having an acryl group to a diisocyanate-based compound having an isocyanate group that reacts with the acryl group. In one example, the diisocyanate-based compound is expressed as chemical formula 1.

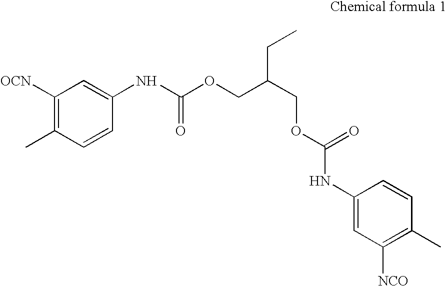

In another aspect, the polarizer includes a polarizing film, a compensation film formed on the polarizing film, a surface protective film formed on the compensation film, and an adhesive interposed between the compensation film and the surface protective film to bond the compensation film to the surface protective film.

The adhesive includes a polymer compound which is formed by bonding a polymer having an acryl group to a diisocyanate-based compound having an isocyanate group that reacts with the acryl group.

In still another aspect, the liquid crystal display includes a liquid crystal panel, a polarizer attached to the liquid crystal panel, and an adhesive interposed between the liquid crystal panel and the polarizer to bond the liquid crystal panel to the polarizer.

The adhesive includes a polymer compound which is formed by bonding a polymer having an acryl group to a diisocyanate-based compound having an isocyanate group that reacts with the acryl group.

### BRIEF DESCRIPTION OF THE DRAWINGS

The above and other advantages of the present invention will become readily apparent by reference to the following detailed description when considered in conjunction with the accompanying drawings wherein:

FIG. 1 is a sectional view showing a liquid crystal display (LCD) according to an embodiment of the present invention;

FIG. 2 is a detailed sectional view of a polarizer shown in FIG. 1;

FIG. 3 is an enlarged perspective view showing a part of a liquid crystal panel of FIG. 1;

FIG. 4 is an enlarged perspective view illustrating a bonding part between a polarizer and a liquid crystal panel shown in FIG. 1;

FIG. 5A is an enlarged view showing an internal structure of an adhesive of FIG. 1; and

FIG. 5B is an enlarged view showing an internal structure of an adhesive according to a comparative example.

### DESCRIPTION OF THE EMBODIMENTS

Hereinafter, embodiments of the present invention will be described in detail with reference to accompanying drawings. However, the present invention is not limited to the following embodiments but includes various applications and modifications. The following embodiments are provided to clarify the technical spirit disclosed in the present invention and to sufficiently transmit the technical spirit of the present invention to the one having ordinary knowledge and skill in this field. Therefore, the scope of the present invention should not be limited to the following embodiments. In addition, the size of the layers and regions of the attached drawings along with the following embodiments may be-simplified or exaggerated for precise explanation or emphasis and the same reference numeral represents the same component.

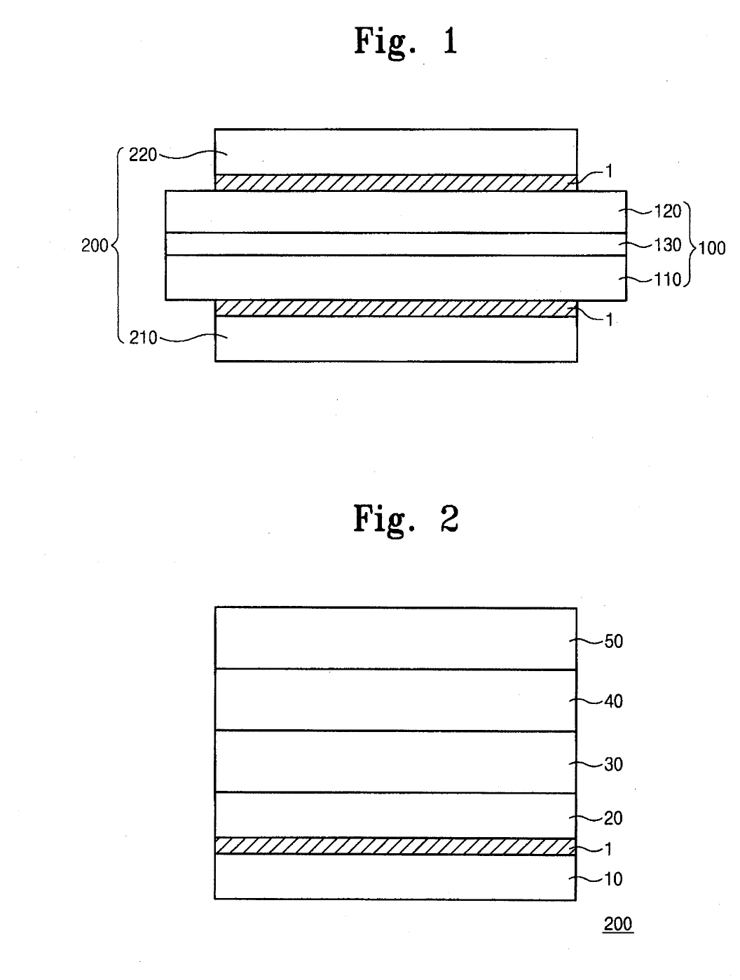

FIG. 1 is a sectional view showing a liquid crystal display (LCD) according to an embodiment of the present invention.

Referring to FIG. 1, the LCD includes a liquid crystal panel 100 and a polarizer 200. The liquid crystal panel 100 has first and second substrates 110 and 120 facing each other and a liquid crystal layer 130 interposed between the first and second substrates 110 and 120. The polarizer 200 includes first and second polarizers 210 and 220, in which the first polarizer 210 is attached to the first substrate 110 and the second polarizer 220 is attached to the second substrate 120.

The liquid crystal panel 110 is bonded to the polarizer 200 by means of an adhesive 1. The liquid crystal panel 110 bonded to the polarizer 200 by means of the adhesive 1 can be detached from the polarizer 200, if necessary. For instance, when rework is required due to a process fault, the worker can detach the polarizer 200 from the liquid crystal panel 110.

FIG. 2 is a detailed sectional view of the polarizer shown in FIG. 1.

Referring to FIG. 2, each of the first and second polarizers 210 and 220 of the polarizer 200 includes a surface protective film 10, a compensation film 20, support films 30 and 50, and a polarizing film 40 in addition to the adhesive 1. The first and second polarizers 210 and 220 have the same structure. The surface protective film 10 is adjacent to the liquid crystal panel 100. The first and second polarizers 210 and 220 are symmetrically aligned with respect to the liquid crystal panel 100.

The surface protective film 10 is formed at the outermost layer of the polarizer 200 to prevent an inner portion of the polarizer 200 from being contaminated or damaged during the process. The surface protective film 10 is removed when the polarizer 200 is attached to the liquid crystal panel 100. The adhesive 1 is coated on the compensation film 20, thereby forming an adhesive layer. The surface protective film 10 is bonded to the compensation film 20 by means of the adhesive 1. In addition, after the surface protective film 10 has been removed, the liquid crystal panel 100 is bonded to the polarizer 200 by means of the adhesive 1.

The compensation film 20 compensates for phase change of light that passes through the liquid crystal layer 130. Liquid crystal has anisotropic refractive index and light that passes through the liquid crystal layer 130 in the lateral direction represents phase change greater than that of light passing through the liquid crystal layer 130 in the front direction, causing degradation of the image quality. The compensation film 20 compensates for the phase change of the light that passes through the liquid crystal layer 130 in the lateral direction, thereby improving the image quality in the lateral direction and widening the viewing angle.

The polarizing film 40 performs a polarizing function. The polarizing film 40 can be obtained by adding iodine or dichromatic dye to a PVA (poly vinyl alcohol) layer which is elongated in a predetermined direction. The polarizing film 40 absorbs light components which are vibrated in the elongation axis direction and transmits light components which are vibrated vertically to the elongation axis direction.

A pair of support films 30 and 50 are provided at both sides of the polarizing film 40. The support films 30 and 50 are classified into first support film 30 and second support film 50 according to the position thereof. The first support film 30 is positioned between the compensation film 20 and the polarizing film 40, and the second support film 50 is positioned on the polarizing film 40. An additional protective film corresponding to the surface protective film 10 can be formed on the second support film 50. In one example, the support films 30 and 50 include TAC (triacetate cellulose) having predetermined endurance and support both surfaces of the polarizing film 40 to improve endurance, mechanical strength and heatproof humidity-resistant characteristics of the polarizing film 40.

Among the surface protective film 10, the compensation film 20, the first support film 30, the polarizing film 40 and the second support film 50, only the polarizing film 40 actually performs the polarizing function and the remaining films perform additional functions. Thus, the above films, except for the polarizing film 40, can be selectively used in the polarizer 200.

Meanwhile, a coupling member is provided to couple two films adjacent to each other in the longitudinal direction among the surface protective film 10, the compensation film 20, the first support film 30, the polarizing film 40 and the second support film 50. The coupling member may include the adhesive 1 that couples the liquid crystal panel 100 to the polarizer 200 or couples the surface protective film 10 to the compensation film 20. Once the compensation film 20, the first support film 30, the polarizing film 40 and the second support film 50 are coupled to each other, they are rarely needed to be separated from each other. Accordingly, the compensation film 20, the first support film 30, the polarizing film 40 and the second support film 50 may be fixedly coupled to each other by means of a bonding agent. If the above elements are coupled to each other by means of the bonding agent, other than the adhesive 1, detachment work for the above elements is very difficult.

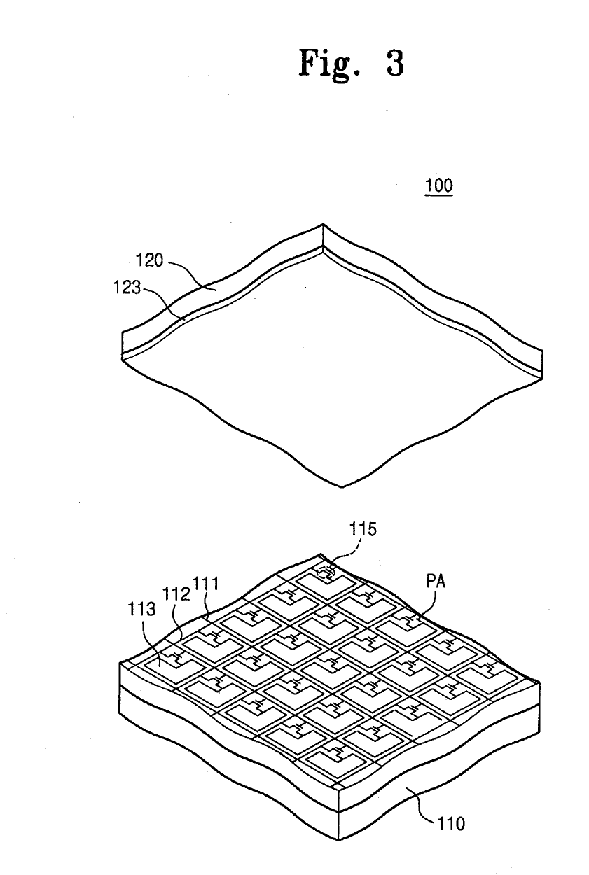

FIG. 3 is an enlarged perspective view showing a part of the liquid crystal panel of FIG. 1.

Referring to FIG. 3, a plurality of gate lines 111 and data lines 112 are formed on the first substrate 110. The gate lines 111 cross the data lines 112, thereby forming a plurality of pixel areas PA. Pixel electrode 113 and thin film transistor 115 are provided in each pixel area. The second substrate 120 includes a common electrode 123 that faces the pixel electrode 113.

Hereinafter, the operation of the LCD will be described with reference to FIGS. 1 to 3.

The first and second polarizers 210 and 220 are attached to the liquid crystal panel 100 such that the transmission axes of the polarizing films 40 of the first and second polarizers 210 and 220 are perpendicular to each other. Liquid crystal is aligned in the liquid crystal layer 130. The liquid crystal has an oval shape having a short axis and a long axis. The alignment direction of the liquid crystal is defined according to the direction of the long axis. If the electric field is not applied to the liquid crystal layer 130, the liquid crystals are aligned parallel to the first and second substrates 110 and 120. In addition, the liquid crystals in the first substrate 110 are perpendicular to the liquid crystals in the second substrate 120, in which the liquid crystals are continuously twisted.

In this state, the light passes through the first polarizer 210 so that the light is linearly polarized. Then, the linearly polarized light passes through the liquid crystal layer 130. At this time, the phase of the linearly polarized light is changed according to alignment of the liquid crystals that are twisted. Then, the phase-changed light passes through the second polarizer 220 so that the image is displayed.

During the operation of the LCD, gate signals and data signals are applied to the gate lines 111 and data lines 112, respectively. As the thin film transistor 115 is turned on by means of the gate signal, data voltage corresponding to the data signal is applied to the pixel electrode 113. In addition, constant common voltage is applied to the common electrode 123. An electric field is applied to the liquid crystal layer due to the potential difference between the data voltage and the common voltage. The liquid crystal has an anisotropic dielectric constant and the alignment direction thereof is changed according to the electric field applied thereto.

As the electric field is applied to the liquid crystals, the liquid crystals are aligned vertically to the first and second substrates 110 and 120. In this state, light passes through the first polarizer 210 so that the light is linearly polarized and the linearly polarized light passes through the liquid crystal layer 130. At this time, the linearly polarized light is not subject to the phase change, so the light does not pass through the second polarizer 220, and thus, the LCD goes into a black state. The liquid crystals can be tilted relative to the first and second substrates 110 and 120 by adjusting the intensity of the electric field. In this case, the phase change is incurred in the light due to the tilting angle of the liquid crystals, so some of the light passes through the second polarizer 220, thereby displaying an image having a predetermined gray scale.

Since the LCD displays the image using the optical characteristics of the liquid crystals, the image quality may be degraded if the characteristics of the light are changed due to a medium aligned in the light path. In particular, in the case of the compensation film 20 that compensates for the phase change of the light passing through the liquid crystal layer 130, the phase change of the light passing through the compensation film 20 may remarkably increase as the physical property of the compensation film 20 varies. If the phase change of the light becomes increased, stain is formed on the image being displayed, that is, the image quality is degraded.

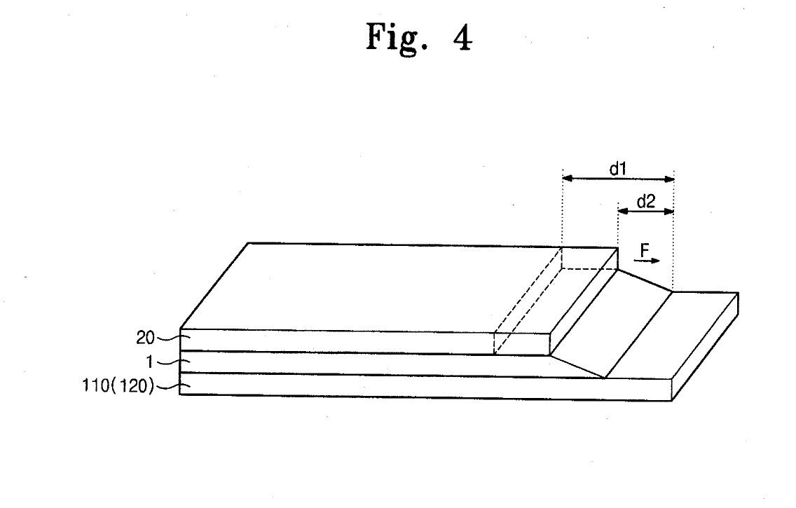

FIG. 4 is an enlarged perspective view illustrating a bonding part between the polarizer and the liquid crystal panel shown in FIG. 1.

Referring to FIG. 4, the compensation film 20 is attached to the top surface of the first substrate 110 (or the second substrate 120) by means of the adhesive 1. The LCD fabrication process includes a heat treatment process. For instance, after the liquid crystal panel 100 is assembled with the polarizer 200, heat is applied thereto in order to test the operational state of the LCD at the temperature of about 60° C. As the heat is applied during the heat treatment process, the compensation film 20 is expanded. In addition, since the compensation film 20 has predetermined elasticity, the compensation film 20 is compressed after the heat treatment process has been finished. The expansion and compression of the compensation film 20 may vary depending on the physical property of the compensation film 20, such as the elastic coefficient, and the physical property of the adhesive 1, such as the adhesive strength.

That is, when the compensation film 20 is compressed, the adhesive 1 generates a predetermined support force F, so the compensation film 20 is prevented from returning into the original position thereof. Thus, when the adhesive 1 is not provided, if the theoretical compression distance of the compensation film 20 after expansion is the first distance d1 and the actual compression distance of the compensation film 20 influenced by the support force F is the second distance d2, the first distance d1 is larger than the second distance d2. In this case, the phase change of the light passing through the compensation film 20 may increase proportional to the support force F and the difference between the first and second distances (Δd=d1−d2) as expressed below.

Phase change=proportional constant×(F×Δd)

The proportional constant relates to the physical property of the compensation film 20, such as the elastic coefficient. Based on the above equation, two methods can be employed to reduce the phase change of the light.

The first method is to change the physical property of the compensation film 20, such as the elastic coefficient. However, since the compensation film 20 consists of specific compounds to compensate for the phase change of the light passing through the liquid crystal layer 130, changing the physical property of the compensation film 20 is limited. In addition, the compensation film 20 is selectively used in the polarizer 200, so the first method is useless if the compensation film 20 is not used.

The second method is to change the physical property of the adhesive 1. In the above equation, the support force F and the difference Δd between the first and second distances relates to the adhesive strength of the adhesive 1. That is, if the adhesive 1 has a “soft” property by a predetermined degree, the support force F and the difference Ad between the first and second distances can be reduced. The second method relates to the adhesive 1 that is essentially used in the polarizer 200, so the second method is applicable for other films coated with the adhesive 1 in the polarizer 200, in addition to the compensation film 20.

The adhesive 1 of the present embodiment is improved to have a soft physical property in accordance with an embodiment of the present invention. Hereinafter, the operational principle of the soft adhesive 1 will be described with reference to accompanying drawings. In addition, the composition of the adhesive 1 will be described in detail.

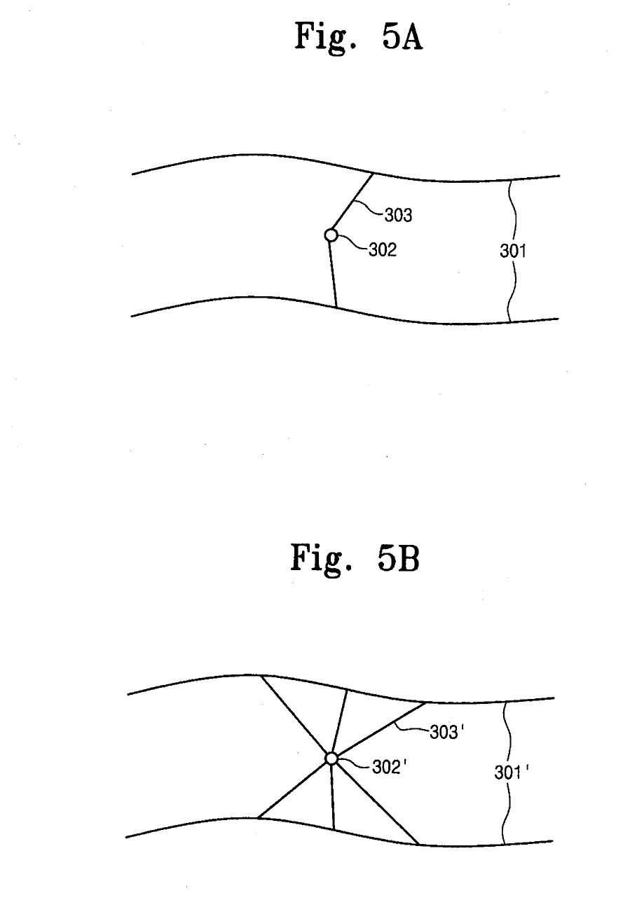

FIG. 5A is an enlarged view showing an internal structure of the adhesive shown in FIG. 1 and FIG. 5B is an enlarged view showing an internal structure of the adhesive according to a comparative example.

Referring to FIG. 5A, the adhesive 1 includes a plurality of polymers 301 and a cross-linking agent 302. The polymers 301 have adhesive property and are connected to each other by means of the cross-linking agent 302. In FIG. 5A, a part connecting the polymer 301 to the cross-linking agent 302 is referred to as a linking branch 303 for the purpose of convenience. The cross-linking agent 302 has two linking branches 303 per one molecule in one example. The two linking branches 303 are used to connect two different polymers 301.

Referring to FIG. 5B, two different polymers 301′ are connected to each other through the cross-linking agent 302′. The cross-linking agent 302′ has six linking branches 303′ per molecule in this example. However, this is for illustrative purposes only and the cross-linking agent 302′ may have more than six linking branches 303′ in other examples. If the number of linking branches 303′ per molecule increases, the polymers 301′ can be connected to each other through a greater number of linking branches 303′.

The number of linking branches 303 that interconnect the polymers 301 exerts an influence upon the physical property of the adhesive 1. In the present embodiment, the number of linking branches 303 is reduced in the adhesive 1 so that the adhesive 1 has a soft property. The detailed composition of the polymer and the cross-linking agent is as follows.

A polymer having an acryl group is employed in the present embodiment. Table 1 shows several examples of the polymer having the acryl group.

TABLE 1

| | | |
|---|---|---|
| Polymer | Polyacrylate | Polymethacrylate |
| Unit StructuralFormular(R: alkyl groupexpresssed by:CₘH₂ₘ₊₁) | 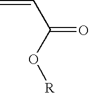 | 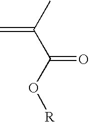 |

(° C.) Glass Transition Temperature

| | | |
|---|---|---|
| R:H | 80~95 | − |
| R:CH₃ | 3 | 60~105 |
| R:C₂H₅ | −27 | 47 |
| R:C₃H₇ | −40 | 25~33 |
| R:C₄H₉ | −57 | 10~17 |

Referring to Table 1, polyacrylate and polymethacrylate are used as the polymer having the acryl group. The polyacrylate is obtained by polymerizing the acrylate monomers. The acrylate monomer includes carbon having the double bond. During the polymerization process, the double bond is changed into the single bond and adjacent monomers are bonded to each other.

The polymethacrylate is obtained by polymerizing the methacrylate monomers. The methacrylate monomers are different from the acrylate monomers in that a methyl group (CH₃) is bonded to one of double bonded carbons.

The acrylate or methacrylate has an alkyl group R. The alkyl group R represents the atomic group in which one hydrogen is removed from a chain-shaped hydrocarbon such as an alkane, and is expressed as a formula “CₘH₂ₘ₊₁”, wherein m includes 0 or positive integers. If m is 0, it does not function as the alkyl group R including carbon because the formula merely represents hydrogen H. However, in the following description, it will be regarded as the alkyl group R even if m is 0 for the sake of convenience.

As shown in Table 1, the glass transition temperature of the polyacrylate or the polymethacrylate varies depending on the number of carbons in the alkyl group. In general, the physical property of a material is significantly changed on the basis of the glass transition temperature. Polymer resin has a soft property at the temperature higher than the glass transition temperature and has a rigid property at the temperature lower than the glass transition temperature.

As the number of carbons in the alkyl group increases, the glass transition temperature is lowered. Under the same number of carbons, the glass transition temperature of the polyacrylate is lower than that of the polymethacrylate. The glass transition temperature of acryl polymer suitable for the adhesive 1 is set to the normal temperature (about 25° C.) corresponding to the operational environment of the LCD. If the glass transition temperature is too low relative to the normal temperature, the adhesive 1 may have greater fluidity at the normal temperature, so the adhesive 1 flows out from between the liquid crystal panel 100 and the polarizer 200. In addition, if the glass transition temperature is too high relative to the normal temperature, the adhesive 1 may be solidified at the normal temperature.

In the case of the adhesive 1 including the polyacrylate, the alkyl group preferably includes hydrogen H, a methyl group CH₃, an ethyl group C₂H₅, a propyl group C₃H₇, and a butyl group C₄H₉. In addition, the polyacrylate and the polymethacrylate are preferably mixed with each other in a predetermined mixing ratio such that the mixture has the glass transition temperature corresponding to the normal temperature, instead of individually using the polyacrylate or the polymethacrylate.

In one example, the cross-linking agent includes a diisocyanate-based compound as expressed in chemical formula 1 below.

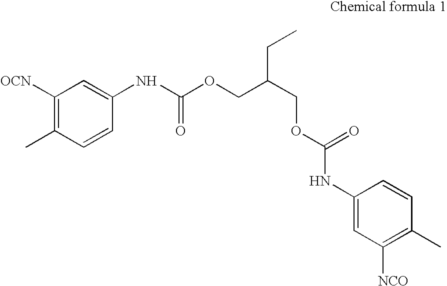

The diisocyanate-based compound has two isocyanate groups (OCN) per molecule. The two isocyanate groups react with the acryl group as expressed in reaction formula 1 below. Reaction formula 1 shows the reaction between the polyacrylate having hydrogen H and the diisocyanate-based compound. If hydrogen is replaced with the alkyl group R in reaction formula 1, reaction formula 1 can be applied to a reaction between a polymer having the acryl group and the diisocyanate-based compound expressed in chemical formula 1.

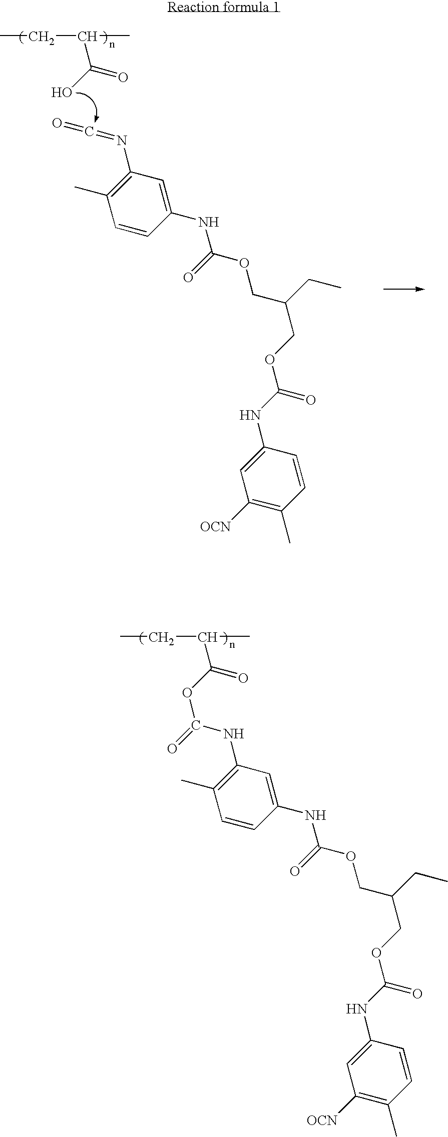

As shown in reaction formula 1, the acryl group attacks the isocyanate group, so oxygen of the acryl group is bonded again to carbon of the isocyanate group. Since the diisocyanate-based compound has two isocyanate groups, two different polymers are connected per molecule of the diisocyanate-based compound. As a result, a link branch connecting the two different acryl polymers is formed.

In detail, the adhesive 1 includes a polymer compound expressed as chemical formulas 2 to 4 as shown below, in which two different acryl polymers are coupled with one molecule of the diisocyanate-based compound. In chemical formulas 2 to 4, R or R′ represents hydrogen or the alkyl group and n or n′ represents a positive integer.

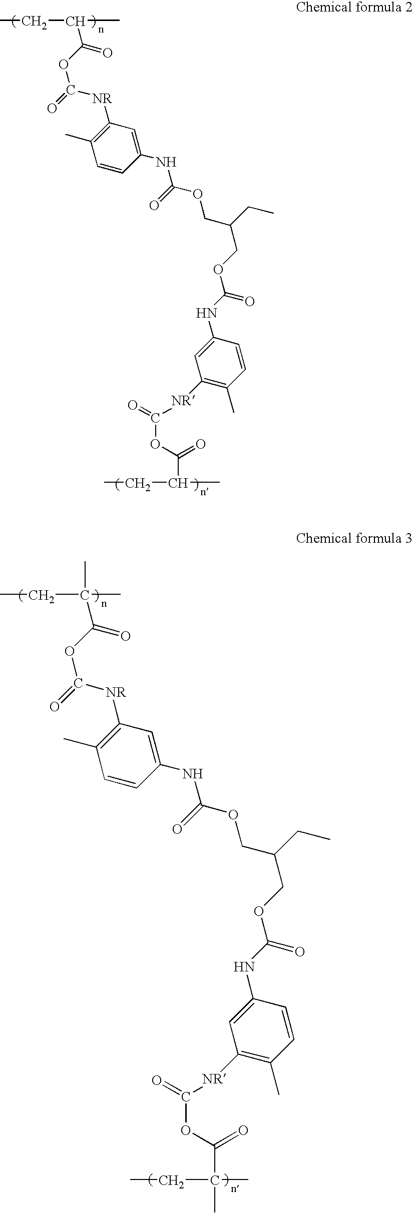

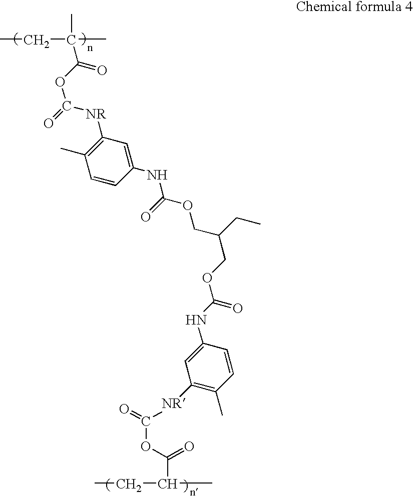

The compound of chemical formula 2 exhibits the case in which the diisocyanate-based compound is bonded to two different polyacrylates, the compound of chemical formula 3 exhibits the case in which the diisocyanate-based compound is bonded to two different polymethacrylates, and the compound of chemical formula 4 exhibits the case in which different polyacrylates and different polymethacrylates are bonded to the diisocyanate-based compound while being coupled to each other. The compound of chemical formula 4 can be formed because the polymer having the acryl group used in the adhesive 1 is prepared by mixing the polyacrylate with the polymethacrylate.

As described above, since the diisocyanate-based compound has only two isocyanate groups, polymers having acryl groups different from each other are coupled to each other by means of two link branches. Since the number of the link branches is limited, the number of bonds between polymers having the acryl groups can be appropriately reduced. As a result, the adhesive 1 has a soft property and the phase change of light that passes through the optical film attached by means of the adhesive 1 can be minimized.

The diisocyanate-based compound having two isocyanate groups can be formed through various methods. In one example, a method as expressed in reaction formula 2 below can be employed.

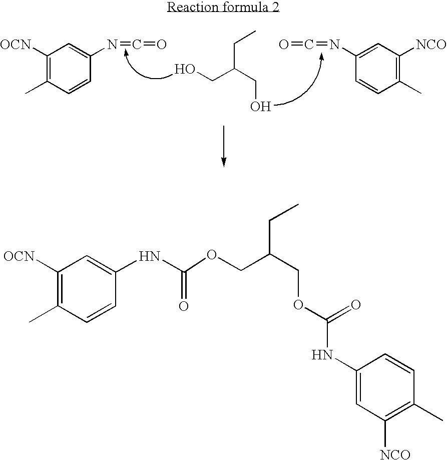

Referring to reaction formula 2, 2 moles of toluene diisocyanate react with one mole of 2-ethyl-1.3-propanediol. The alcohol group (OH) of 2-ethyl-1.3-propanediol attacks the isocyanate group (OCN) of toluene diisocyanate, so oxygen of the alcohol group is bonded again to carbon of the isocyanate group.

According to the embodiments described above, the adhesive is improved to have a soft property, so the phase change of light passing through the optical film employing the adhesive can be reduced. As a result, degradation of the image quality caused by the phase change of light can be prevented.

Although embodiments of the present invention have been described, it is understood that the present invention should not be limited to these embodiments but various changes and modifications can be made by one of ordinary skill in the art within the spirit and scope of the present invention as hereinafter claimed.

What is claimed is:

1. An adhesive, comprising:
a polymer compound which is formed by bonding a polymer having an acryl group to a diisocyanate-based compound having an isocyanate group that reacts with the acryl group, wherein the diisocyanate-based compound is expressed as

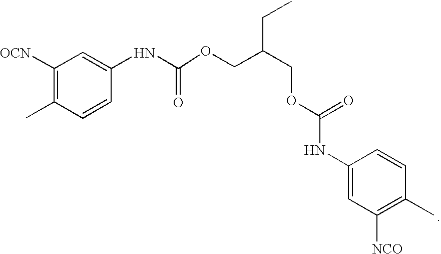

2. The adhesive as claimed in claim 1, wherein the polymer comprises at least one of a polyacrylate and a polymethacrylate.

3. The adhesive as claimed in claim 2, wherein the polymer comprises one of hydrogen or an alkyl group.

4. The adhesive as claimed in claim 3, wherein the alkyl group has four carbon atoms or less.

5. The adhesive as claimed in claim 1, wherein a maximum of two different polymers is bonded per one molecule of the diisocyanate-based compound.

6. The adhesive as claimed in claim 1, wherein the polymer compound is expressed by at least one of following chemical formulas: 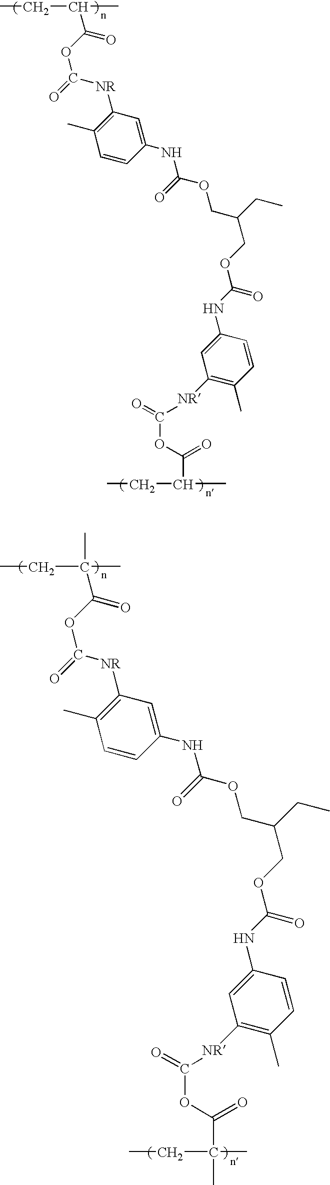 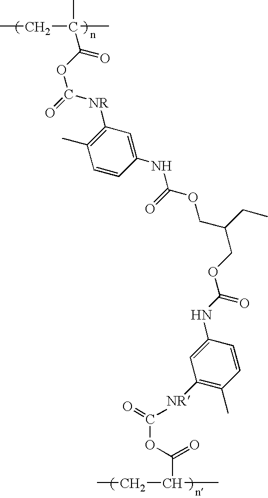
wherein R or R′ represents hydrogen or an alkyl group, and n or n′ represents a positive integer.

7. A polarizer, comprising:
a polarizing film;
a compensation film formed on the polarizing film;
a surface protective film formed on the compensation film; and
an adhesive interposed between the compensation film and the surface protective film to bond the compensation film to the surface protective film, wherein
the adhesive comprises a polymer compound which is formed by bonding a polymer having an acryl group to a diisocyanate-based compound having an isocyanate group that reacts with the acryl group, and further wherein the diisocyanate-based compound is expressed as

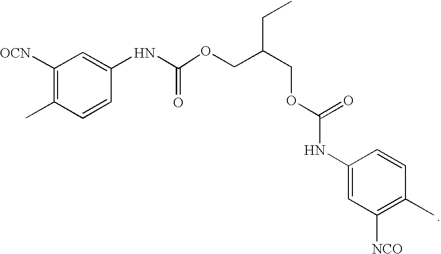

8. The polarizer as claimed in claim 7, wherein the polymer comprises at least one of a polyacrylate and a polymethacrylate.

9. The polarizer as claimed in claim 8, wherein the polymer comprises hydrogen or an alkyl group.

10. The polarizer as claimed in claim 9, wherein the alkyl group has four carbon atoms or less.

11. The polarizer as claimed in claim 7, wherein a maximum of two different polymers is bonded per one molecule of the diisocyanate-based compound.

12. The polarizer as claimed in claim 7, wherein the polymer compound is expressed by at least one of following chemical formulas: 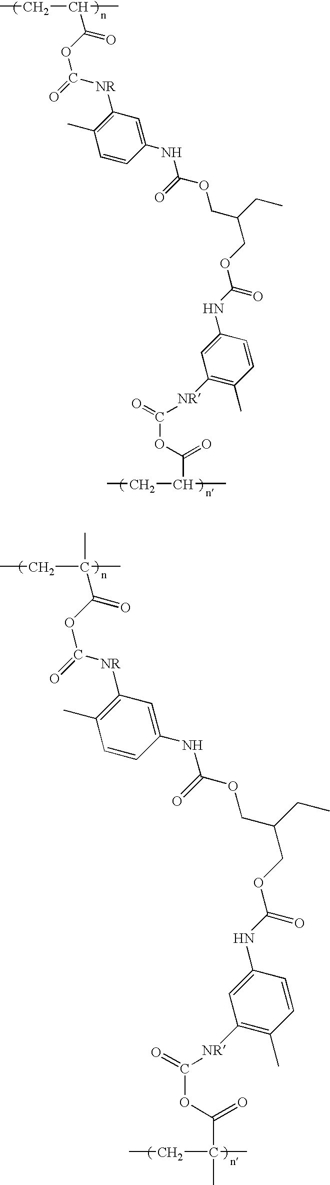 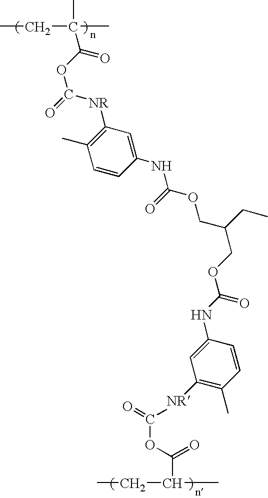
wherein R or R′ represents hydrogen or an alkyl group, and n or n′ represents a positive integer.

13. The polarizer as claimed in claim 7, further comprising a pair of support films that face each other while the polarizing film is interposed therebetween.

14. A liquid crystal display, comprising:
a liquid crystal panel;
a polarizer attached to the liquid crystal panel; and
an adhesive interposed between the liquid crystal panel and the polarizer to bond the liquid crystal panel to the polarizer, wherein
the adhesive comprises a polymer compound which is formed by bonding a polymer having an acryl group to a diisocyanate-based compound having an isocyanate group that reacts with the acryl group, wherein the diisocyanate-based compound is expressed as

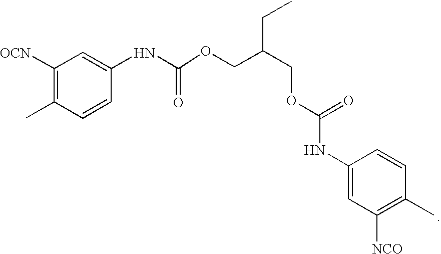

15. The liquid crystal display as claimed in claim 14, wherein the polymer comprises at least one of a polyacrylate and a polymethacrylate.

16. The liquid crystal display as claimed in claim 15, wherein the polymer comprises hydrogen or an alkyl group.

17. The liquid crystal display as claimed in claim 16, wherein the alkyl group has four carbon atoms or less.

18. The liquid crystal display as claimed in claim 14, wherein a maximum of two different polymers is bonded per one molecule of the diisocyanate-based compound.

19. The liquid crystal display as claimed in claim 14, wherein the polymer compound is expressed by at least one of following chemical formulas: 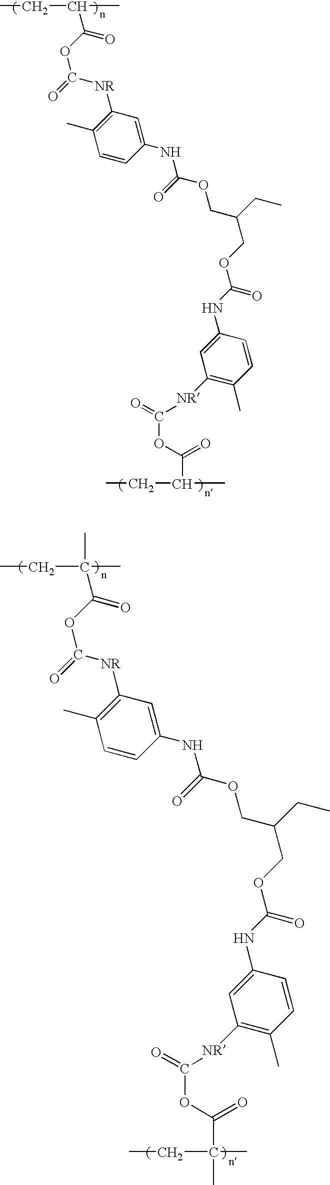 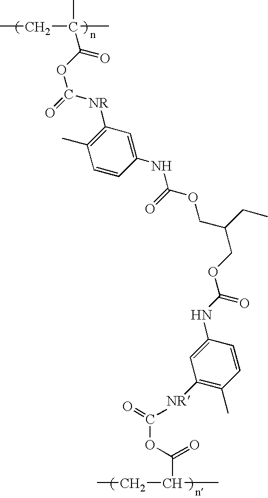
wherein R or R′ represents hydrogen or the alkyl group, and n or n′ represents a positive integer.

20. The liquid crystal display as claimed in claim 14, wherein the polarizer comprises:
a polarizing film;
a pair of support films that face each other while the polarizing film is interposed therebetween; and
a compensation film formed on any one of the support films.
